(19) United States
(12) Patent Application Publication
(10) Pub. No.: US 2005/0248258 A1
(43) Pub. Date: Nov. 10, 2005

(54) Anode plate structure

(76) Inventors: Ji-Won Lee, Suwon-si (KR); Chul-Ho Lee, Suwon-si (KR)

Correspondence Address: Robert E. Bushnell, Suite 300, 1522 K Street, N.W., Washington, DC, 20005, US

(21) Appl. No.: 11/117,711

(22) Filed: Apr. 29, 2005

(30) Foreign Application Priority Data
Apr. 29, 2004 (KR) 10-2004-0029883

(51) Int. Cl. H01J 1/62; H01J 63/04

(52) U.S. Cl. 313/497; 313/495

(57) ABSTRACT

An anode plate structure for an electron emission display device may be constructed with a cathode plate being a lower plate and an anode plate being an upper plate. The anode plate is arranged opposite to the cathode plate, with an area that is smaller than the surface area of the cathode plate, and the anode plate is located inside the cathode plate when the display device is viewed in a plan view so that all four-side edges of the cathode plate are exposed. At least one data driving electrode and at least one scan driving electrode may be installed on the cathode plate. One, or more anode voltage applying terminal is applied to the anode plate.

### CLAIM OF PRIORITY

This application makes reference to, incorporates the same herein, and claims all benefits accruing under 35 U.S.C. 19 from an application for ANODE PLATE STRUCTURE earlier filed in the Korean Intellectual Property Office on the 29th of Apr. 2004, and there duly assigned Serial No. 10-2004-0029883.

### BACKGROUND OF THE INVENTION

1. Technical Field

The present invention relates to an anode plate structure for an electron emission display device, and more particularly, to an anode plate structure in a positional relation between an anode plate as an upper plate, and a cathode plate as a lower plate.

2. Related Art

In general, an electron emission display device is a flat panel display device which collides electrons emitted from a primary plate with a phosphor layer formed on a secondary plate, and emits the electrons to display a predetermined visual image. The electron emission display device includes the electron emission display device using a hot cathode as an electron source, and the electron emission display device using a cold cathode as the electron source.

The electron emission display device using a cold cathode as the electron source generally includes a field emission display (FED). The FED includes a field emitter (FE) electron emission display device, a metal-insulator-metal (MIM) electron emission display device, a metal-insulator-semiconductor (MIS) electron emission display device, and a surface conduction electron-emitting display (SED).

The FED uses a quantum mechanical tunnel effect and generally has a three-electrode tube structure in which electrons are emitted from an electric field formed by a cathode electrode, a gate electrode, and an anode electrode, and collide with a phosphor layer formed on the anode electrode to be excited and emitted.

In an FED, the anode plate as the upper plate is located to be opposite to the cathode plate as the lower plate. The upper and lower relation between the anode plate and the cathode plate is a positional correlation between the anode plate and the cathode plate in a cross-section view.

When the anode plate as the upper plate and the cathode plate as the lower plate are viewed from the upside, that is, in a plane view of a device, the anode plate as the upper plate is located on a cathode plate as the lower plate, but the side portions of the anode plate protrude farther from side portions of the cathode plate as the lower plate in a side ways direction. That is, the entire portion of the anode plate is not located within the boundaries of the cathode plate which is located under the anode plate, but a portion of the anode plate extends from the edges of the cathode plate and is exposed outside the boundaries of the cathode plate.

An anode voltage applying terminal is installed at the side portions of the anode plate that protrudes from the side portions of the cathode plate.

In the anode plate substructure, since the side portions of the anode substrate protrude farther from the side portion of the cathode plate in the side ways direction, the anode plate covers a portion of the edges of the cathode plate. As such, it becomes difficult to install electrodes at the side portions of the cathode plate which are covered by the side portions of the anode plate.

Accordingly, when power is applied to an anode plate for an FED, a voltage drop occurs and causes a diminution in the degree of image uniformity required across a panel. In addition, since a space for dual scanning cannot be obtained on a cathode plate, the anode plate on which high-speed data processing can be performed can not be used.

### SUMMARY OF THE INVENTION

It is an object of the present invention to provide an improved anode plate structure for a field emission display (FED) capable of preventing diminution of image uniformity caused by voltage drop.

It is another object to provide an anode plate structure for a field emission display (FED) capable of providing a space for a driving electrode enabling dual scanning on a cathode electrode.

According to an aspect of the present invention, there is provided an anode plate structure for an electron emission display device. The anode plate structure may be constructed with a cathode plate being a lower plate, and an anode plate being an upper plate, wherein the anode plate is opposite to the cathode plate, has an area smaller than the area of the cathode plate, and is located inside the cathode plate so that all of the edges of the four sides of the cathode plate are exposed.

A data driving electrode may be installed on the cathode plate.

A scan driving electrode may also be installed on the cathode plate.

Alternatively, the data driving electrode and the scan driving electrode may be installed on the cathode plate.

The scan driving electrode may have dual scan driving electrodes installed at the side edges of the opposite sides of the cathode plate.

The data driving electrode may have two data driving electrodes located to be opposite to each other.

An anode voltage applying terminal may be applied to the anode plate.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a plan view of an upper plate structure and a lower plate structure of a field emission display (FED); and

FIG. 2 is a plan view of an anode plate structure of a field emission display (FED) which may be constructed according to the principles of the present invention.

### DETAILED DESCRIPTION OF THE INVENTION

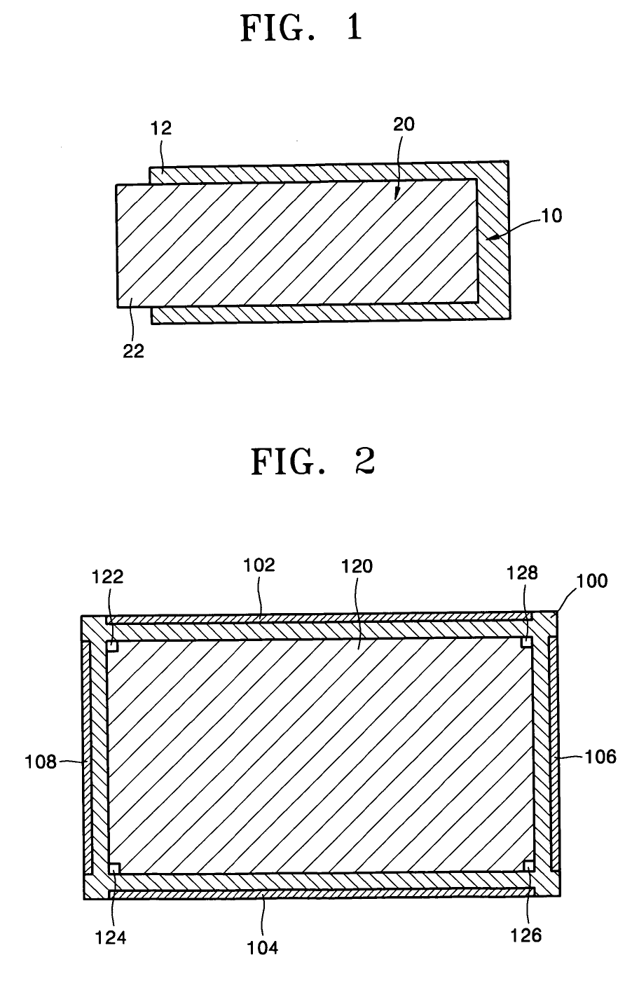

FIG. 1 is a plan view of a FED showing a positional relation between a cathode plate 10 as a lower plate and an anode plate 20 as an upper plate. Thus, FIG. 1 is a top plan view of the upper plate and the lower plate.

Referring to FIG. 1, the shape of a stack structure of a FED as constructed according to a contemporary practice, anode plate 20 as the upper plate is located to be opposite to cathode plate 10 as the lower plate. The upper and lower relation between anode plate 20 and the cathode plate 10 is a positional correlation between anode plate 20 and cathode plate 10 in a cross-section view.

As shown in FIG. 1, when anode plate 20 as the upper plate and cathode plate 10 as the lower plate are viewed from the top, or upper side, that is, in a plan view, anode plate 20 as the upper plate is located on cathode plate 10 as the lower plate, but side portion 22 of anode plate 20 protrude farther from side portion 12 of cathode plate 10 as the lower plate in a side ways direction. That is, the entire portion of anode plate 20 is not located either co-extensively or entirely inside cathode plate 10 which is located under anode plate 20; instead, portion 22 of anode plate 20 extends beyond the edges of cathode plate 10 and is exposed outside the boundaries of cathode plate 10.

Although not shown, a terminal for applying voltage to anode plate 20 is installed at side portion 22 of anode plate 20 which protrudes from side portion 12 of cathode plate 10.

In the conventional design of an anode plate substructure, because side portions 22 of anode substrate 20 protrude farther from side portion 12 of cathode plate 10 in a side ways direction, anode plate 20 covers a portion of the edges of cathode plate 10. As such, it becomes difficult to install electrodes at side portions 12 of cathode plate 10 which are covered by side portions 22 of anode plate 20.

Accordingly, when power is applied to an anode plate for an FED, a voltage drop occurs and causes a degradation of the image uniformity required across the surface a panel. In addition, since a space for dual scanning cannot be obtained on a cathode plate, the anode plate on which high-speed data processing can be performed can not be used.

An exemplary embodiment of the present invention will be described with reference to the accompanying drawing.

FIG. 2 is a plane view of an anode plate structure for a field emission display (FED) constructed according to the principles of the present invention. The anode plate structure for the field emission display (FED) of FIG. 2 includes a cathode plate 100 which is a lower plate, and an anode plate 120 which is an upper plate. In addition, anode plate 120 is located on cathode plate 100 and has an area smaller than the surface area of cathode plate 100. In addition, anode plate 120 is located inside of the edges bounding the surface area of cathode plate 100 when the FED is viewed in a top plan view.

That is, anode plate 120 does not protrude beyond any one of the edges of the side portions of cathode plate 100, and is located entirely within, and completely inside the edges of cathode plate 100 so that the edges of cathode plate 100 are not covered or otherwise obsured by anode plate 120.

Since anode plate 120 does not cover the edges of cathode plate 100, none of the edges of cathode plate 100 are covered by anode plate 120 and all of those edges are exposed outside the boundaries of cathode plate 100 when the FED is viewed in a top view.

When cathode plate 100 has a rectangular shape, a first scan driving electrode 106 and a second scan deriving electrode 108 which are dual scan driving electrodes for dual scanning, may be installed along the side edges of opposite sides of cathode plate 100. Neither first scan driving electrode 106 nor second scan driving electrode 108 are covered by anode plate 120 which is located on cathode plate 100; instead both electrodes 106, 108 are exposed to the upside.

Data driving electrodes 102 and 104 are installed at the remaining edges of cathode plate 100 other than those edges at where first scan driving electrode 106 and second scan driving electrode 108 are installed, in a configuration with electrodes 102, 104 opposite to each other to serve as electrodes for driving data.

Neither of data driving electrodes 102 nor 104 are covered by anode plate 120 located on cathode plate 100, but both electrodes 102, 104 are exposed to the upside.

Thus, data driving electrodes 102, 104, together with first driving electrode 106 and second scan driving electrode 108, are installed on cathode plate 100, but anode plate 120 which is located on cathode plate 100, has an area smaller than the surface area of cathode plate 100. As a result, driving electrodes 102, 104 are not covered by anode plate 120 which is located wholly inside the edges of cathode plate 100, but are instead exposed to the upside.

Thus, a sufficient space for installing each of the driving electrodes is obtained on cathode plate 100 so that the FED may be designed to accommodate the required driving electrodes.

Meanwhile, anode voltage applying terminals 122, 124, 126, and 128 are installed on anode plate 120. In particular, when anode plate 120 has a rectangular shape, anode voltage applying terminals 122, 124, 126, and 128 are individually installed at each of edges of anode plate 120, and a predetermined voltage is applied to anode plate 120.

In order to display an image, a negative scan pulse is applied to a scan driving electrode and a positive data pulse is applied to a data driving electrode, and a positive anode voltage is applied to an anode electrode of anode plate 120. Then, electrons are tunneled to the data driving electrode from the scan driving electrode and are accelerated toward the anode electrode.

In the structure described in the foregoing detailed description, all of the edges of a cathode plate located under an anode plate are exposed to the upside, and a predetermined driving electrode is installed at the edges of the cathode plate. Nonuniformity in images caused by applying the driving voltage to an electrode installed at only a portion of the edges of the cathode plate is thereby prevented.

As described above, the anode plate structure for an electron emission display device which may be constructed according to the principles of the present invention has the following effects. First, an anode plate is located on a cathode plate without covering the edges of the cathode plate, and a driving electrode is installed at the edges of the cathode plate that are not covered by the anode plate so that diminution of image uniformity caused by the occurrence of a voltage drop when applying power to the anode plate for a field emission display (FED) is prevented, and the image uniformity required over the width and breath of a panel is improved. Second, the anode plate is located on the cathode plate so that all four-side edges of the cathode plate are exposed in a plan view, and a dual scan driving electrode may be installed at the edges of the cathode plate so that high-speed data processing for dual scanning is enabled.

While the present invention has been particularly shown and described with reference to an exemplary embodiment thereof, it will be understood by those skilled in the art that various changes in form and details may be made therein without departing from the spirit and scope of the invention as defined by the following claims.

1. An anode plate structure for an electron emission display device, comprising:
a cathode plate; and
an anode plate being opposite to the cathode plate having an area smaller than the cathode plate, and being located inside the cathode plate so that all of four-side edges of the cathode plate are exposed.

2. The anode plate structure of claim 1, wherein a data driving electrode is installed on the cathode plate.

3. The anode plate structure of claim 1, wherein a scan driving electrode is installed on the cathode plate.

4. The anode plate structure of claim 1, wherein a dual scan driving electrode is installed at edges of the cathode plate.

5. The anode plate structure of claim 1, wherein an anode voltage applying terminal is applied to the anode plate.

6. The anode plate structure of claim 5, wherein an anode voltage is applied from an exterior of the anode plate to the anode voltage applying terminal.

7. The anode plate structure of claim 5, wherein an anode voltage is applied from the cathode plate to the anode voltage applying terminal.

8. An anode plate structure for an electron emission display device, comprising:
a cathode plate positioned as a lower plate; and
an anode plate positioned as an upper plate, with the anode plate being positioned opposite to the cathode plate, with an area smaller than the cathode plate, the anode plate being positioned inside boundaries formed by side edges of the cathode plate so that all side edges of the cathode plate are exposed when the device is viewed from the upper plate.

9. The anode plate structure of claim 8, further comprising a data driving electrode is installed on the cathode plate.

10. The anode plate structure of claim 8, further comprising a scan driving electrode installed on a side edge of the cathode plate.

11. The anode plate structure of claim 8, further comprising a dual scan driving electrodes installed at opposite side edges of the cathode plate.

12. The anode plate structure of claim 8, further comprised of an anode voltage applying terminal disposed upon the anode plate.

13. The anode plate structure of any one of claims 11, wherein an anode voltage is applied from an exterior of the anode plate to anode voltage applying terminal.

14. The anode plate structure of any one of claims 11, wherein an anode voltage is applied from the cathode plate to the anode voltage applying terminal.

15. The anode plate structure of claim 8, further comprising a plurality of scan driving electrodes disposed on laterally opposite sides of said cathode plate.

16. The anode plate structure of claim 8, further comprising:
a plurality of scan driving electrodes disposed on laterally opposite sides of said cathode plate; and
a plurality of data driving electrodes disposed on different laterally opposite sides of said cathode plate.

17. The anode plate structure of claim 8, further comprising:
a plurality of scan driving electrodes disposed on laterally opposite sides of said cathode plate;
a plurality of data driving electrodes disposed on different laterally opposite sides of said cathode plate; and
an anode voltage terminal disposed on the anode plate.

18. The anode plate structure of claim 8, further comprising:
a plurality of scan driving electrodes disposed on laterally opposite sides of said cathode plate;
a plurality of data driving electrodes disposed on different laterally opposite sides of said cathode plate; and
a plurality of anode voltage terminals applied at different locations on the anode plate.

19. An emission display device, comprised of:
a cathode plate disposed as a lower plate;
an anode plate positioned opposite to the cathode plate as an upper plate, with the anode plate having a surface area smaller than the cathode plate, and with the anode plate located inside a boundary formed by side edges of the cathode plate.

20. The device of claim 19, further comprising:
a plurality of scan driving electrodes disposed on laterally opposite sides of said cathode plate; and
a plurality of data driving electrodes disposed on different laterally opposite sides of said cathode plate; and
a plurality of anode voltage terminals disposed at different locations on the anode plate.
